(19) United States
(12) Patent Application Publication
(10) Pub. No.: US 2015/0325045 A1
(43) Pub. Date: Nov. 12, 2015

(54) MAP DRAWING DEVICE

(71) Applicant: Schlumberger Technology Corporation, Sugar Land, TX (US)

(72) Inventors: Makoto OTSURU, Chiyoda-ku (JP); Shoichiro KUBOYAMA, Chiyoda (JP)

(73) Assignee: Mitsubishi Electric Corporation, Chiyoda-ku, Tokyo (JP)

(21) Appl. No.: 14/655,094

(22) PCT Filed: Feb. 15, 2013
(86) PCT No.: PCT/JP13/53708

§ 371 Date: Jun. 24, 2015

(51) Int. Cl. G06T 17/05; G09B 29/00

(52) U.S. Cl. CPC G06T 17/05; G09B 29/005

(57) ABSTRACT

A map drawing device includes a map data acquirer that acquires map data, a parcel aspect ratio calculator that calculates an aspect ratio of parcels which can minimize the difference between a map in a case of drawing a spherical object from an arbitrary eyepoint on the basis of the map data acquired by the map data acquirer, and a planar map, a polygon generator that generates a polygon for drawing an intermediate map between an earth object and a planar map on the basis of the aspect ratio of parcels which is calculated by the parcel aspect ratio calculator, and a drawer that draws the intermediate map on the basis of the polygon generated by the polygon generator.

### FIELD OF THE INVENTION

The present invention relates to a map drawing device that draws a map while causing a transition between a spherical object and a planar map which the map drawing device draws by using a vector map.

### BACKGROUND OF THE INVENTION

Conventionally, various methods for projecting the earth which is spherical onto a plane to generate a map are known. A problem is, however, that when the earth is projected onto a plane, an error occurs between the earth and a map on the plane. For example, in the case of Mercator projection which serves as the base of maps which we see most frequently, the map is expressed as a map in an area having a high latitude is distorted.

By the way, a function of displaying a spherical earth as a map having a small scale which makes it possible for the entire earth to be seen, and displaying a planar map which is drawn by using a vector map in the case of other scales is required of car navigation systems in recent years. A problem is, however, that because an error exists between the earth and the planar map, as described above, when switching between the earth and the planar map according to a scale change, the appearance of the map changes a lot and a feeling that something is abnormal is provided for the user.

In order to solve this problem, the patent reference 1 discloses a technique of making a transition between an earth object, which consists of a polygon, and a planar map, which is obtained by projecting the earth onto a plane by using a stereographic cylindrical projection, by using an animation.

### RELATED ART DOCUMENT

### Patent Reference

Patent reference 1: Japanese Unexamined Patent Application Publication No. 2009-59099

### SUMMARY OF THE INVENTION

### Problems to be Solved by the Invention

However, although the technique of making a transition between an earth object, which consists of a polygon, and a planar map, which is obtained by projecting the earth onto a plane by using a stereographic cylindrical projection is disclosed in above-mentioned patent reference 1, no reference is made about a technique of making a transition between an earth object and a planar maps which is drawn by using a vector map. Therefore, the technique disclosed by patent reference 1 cannot implement the function required of car navigation systems.

The present invention is made in order to solve this problem, and it is therefore an object of the present invention to provide a map drawing device that can make a transition between an earth object which consists of a polygon and a planar map which is drawn by using a vector map without providing a feeling that something is abnormal.

### Means for Solving the Problem

In accordance with the present invention, there is provided a map drawing device including: a map data acquirer that acquires map data; a parcel aspect ratio calculator that calculates an aspect ratio of parcels which can minimize a difference between a map in a case of drawing a spherical object from an arbitrary eyepoint on the basis of the map data acquired by the map data acquirer, and a planar map; a polygon generator that generates a polygon for drawing an intermediate map between an earth object and a planar map on the basis of the aspect ratio of parcels which is calculated by the parcel aspect ratio calculator; and a drawer that draws the intermediate map on the basis of the polygon generated by the polygon generator.

### Advantages of the Invention

Because the map drawing device in accordance with the present invention makes a transition between the earth object which consists of a polygon and the planar map which is drawn by using a vector map by making the intermediate map, which can minimize the difference between the spherical object and the planar map, intervene, the map drawing device can make a transition between the earth object and the planar map without providing a feeling that something is abnormal.

### BRIEF DESCRIPTION OF THE FIGURES

FIG. 1 is a block diagram showing the structure of a map drawing device in accordance with Embodiment 1 of the present invention;

FIG. 2 is a diagram for explaining a difference between a map, for use in the map drawing device in accordance with Embodiment 1 of the present invention, into which the Earth is partitioned with latitude and longitude, and a map partitioned into parcels;

FIG. 3 is a diagram for explaining a vertex coordinate system of a polygon which constructs an earth object for use in the map drawing device in accordance with Embodiment 1 of the present invention;

FIG. 4 is a diagram for explaining how to determine the vertex coordinates of the polygon which constructs the earth object for use in the map drawing device in accordance with Embodiment 1 of the present invention;

FIG. 5 is a diagram for explaining texture coordinate which are mapped onto a polygon in the map drawing device in accordance with Embodiment 1 of the present invention;

FIG. 6 is a diagram for explaining a coordinate system of the vertices of a polygon which constructs a planar map for use in the map drawing device in accordance with Embodiment 1 of the present invention;

FIG. 7 is a flow chart for explaining the operation of an intermediate polygon coordinate calculator in the map drawing device in accordance with Embodiment 1 of the present invention;

FIG. 8 is a diagram for explaining a method of correcting the vertex coordinates of the polygon which constructs the planar map for use in the map drawing device in accordance with Embodiment 1 of the present invention;

FIG. 9 is a diagram for explaining that perspective projection from an infinite distance results in the same draw result as that of parallel projection in the map drawing device in accordance with Embodiment 1 of the present invention;

FIG. 10 is a diagram showing a relation among a display area, a visual object distance, and an angle of view in the map drawing device in accordance with Embodiment 1 of the present invention;

FIG. 11 is a diagram for explaining a method of moving an eyepoint which is executed by the map drawing device in accordance with Embodiment 1 of the present invention; and

FIG. 12 is a diagram for explaining a scale changing method which is executed by the map drawing device in accordance with Embodiment 1 of the present invention.

### EMBODIMENTS OF THE INVENTION

Hereafter, the preferred embodiments of the present invention will be explained in detail with reference to the drawings.

### Embodiment 1

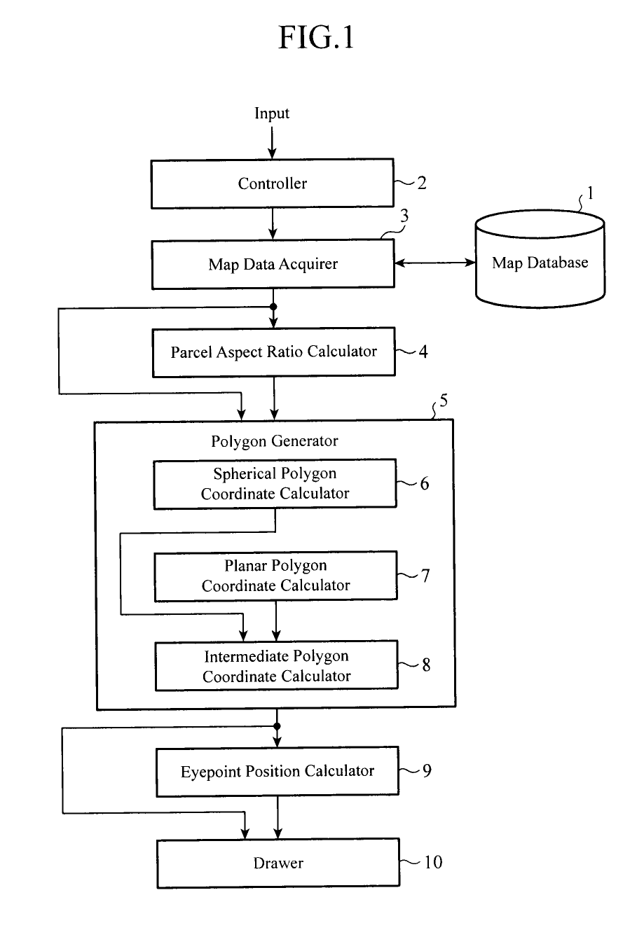

FIG. 1 is a block diagram showing the configuration of a map drawing device in accordance with Embodiment 1 of the present invention. This map drawing device includes a map database 1, a controller 2, a map data acquirer 3, a parcel aspect ratio calculator 4, a polygon generator 5, an eyepoint position calculator 9, and a drawer 10. Further, the above-mentioned polygon generator 5 includes a spherical polygon coordinate calculator 6, a planar polygon coordinate calculator 7, and an intermediate polygon coordinate calculator 8.

The map database 1 stores map data. Map data stored in this map database 1 are read by the map data acquirer 3.

The controller 2 determines parameters necessary for map drawing, such as a range for drawing and a display scale, according to an input from outside the map drawing device. The parameters determined by this controller 2 are sent to the map data acquirer 3.

The map data acquirer 3 acquires necessary map data indicated by the parameters sent thereto from the controller 2 from the map database 1. This map data acquired by the map data acquirer 3 is sent to the parcel aspect ratio calculator 4 and the polygon generator 5.

The parcel aspect ratio calculator 4 calculates an aspect ratio of parcels serving as a reference, concretely, parcels which can minimize a difference between a map at the time of drawing a spherical object from an arbitrary eyepoint, and a planar map on the basis of the map data sent thereto from the map data acquirer 3. This parcel aspect ratio calculated by the parcel aspect ratio calculator 4 is sent to the polygon generator 5.

The polygon generator 5 generates a polygon for map drawing on the basis of both the map data sent thereto from the map data acquirer 3, and the parcel aspect ratio sent thereto from the parcel aspect ratio calculator 4, and sends the polygon to the drawer 10. This polygon generator 5 includes the spherical polygon coordinate calculator 6, the planar polygon coordinate calculator 7, and the intermediate polygon coordinate calculator 8.

The spherical polygon coordinate calculator 6 calculates the coordinates of each vertex of each polygon which constructs an earth object, and sends the vertex coordinates to the intermediate polygon coordinate calculator 8. The planar polygon coordinate calculator 7 calculates the coordinates of each vertex of each polygon which constructs a planar map, and sends the vertex coordinates to the intermediate polygon coordinate calculator 8.

The intermediate polygon coordinate calculator 8 calculates the vertex coordinates of a polygon (referred to as “polygon coordinates” from here on) which constructs an intermediate map between the earth object and the planar map on the basis of both the vertex coordinates sent thereto from the spherical polygon coordinate calculator 6, and the vertex coordinates sent thereto from the planar polygon coordinate calculator 7. These polygon coordinates calculated by the intermediate polygon coordinate calculator 8 are sent, as a polygon for drawing the intermediate map, to the eyepoint position calculator 9 and the drawer 10.

The eyepoint position calculator 9 calculates an eyepoint position parameter showing an eyepoint position at the time of drawing the intermediate map during a transition on the basis of the polygon sent thereto from the polygon generator 5, and sends the eyepoint position parameter to the drawer 10.

The drawer 10 draws the intermediate map between the earth object and the planar map by using both the polygon which is sent thereto from the polygon generator 5 and which constructs the intermediate map, and the eyepoint position parameter sent thereto from the eyepoint position calculator 9.

Next, the operation of the map drawing device in accordance with Embodiment 1 configured as above will be explained. First, the controller 2 determines the parameters necessary for map drawing, such as a range for drawing and a display scale, according to the input from outside the map drawing device, and sends the parameters to the map data acquirer 3.

The map data acquirer 3 which has received the parameters from the controller 2 acquires necessary map data from the map database 1 according to the parameters, and sends the map data to the parcel aspect ratio calculator 4 and the polygon generator 5. It is assumed that the map data acquired from the map database 1 include image data for mapping onto the polygon which constructs the earth object, and vector data in which a vector map for drawing the planar map is described. It is further assumed that the vector map for drawing the planar map is partitioned into rectangles called parcels.

The parcel aspect ratio calculator 4 which has received the map data from the map data acquirer 3 calculates the parcel aspect ratio of the planar map to which the spherical object is made to make a transition, i.e., the planar map which is to be drawn by using the vector map, on the basis of the map data, and sends the parcel aspect ratio to the polygon generator 5.

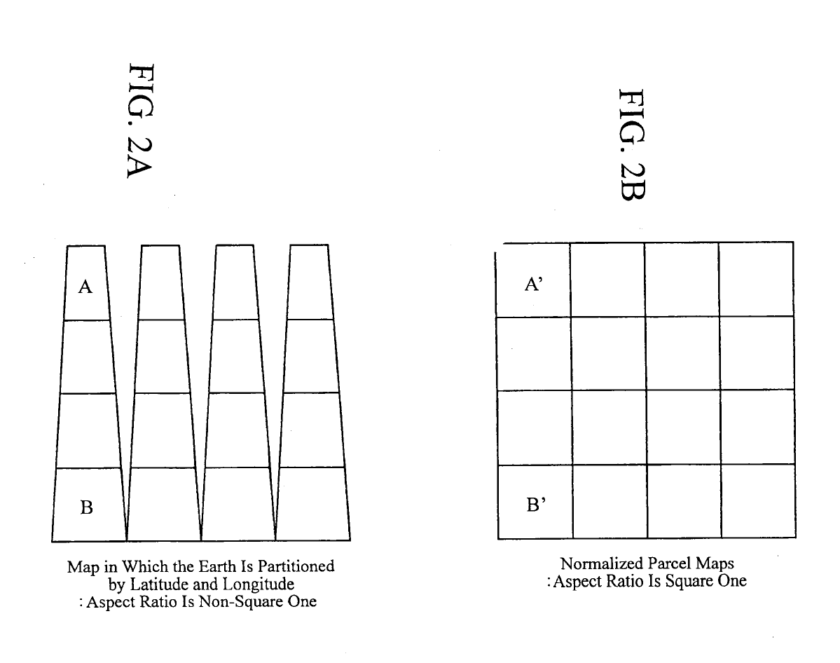

Hereafter, a method of drawing the planar map by using the vector map which is partitioned into parcels will be explained. Map data partitioned into parcels is the one in which a map (map whose aspect ratio is a non-square one), as shown in FIG. 2(a), in which the earth is partitioned by latitude and longitude, is normalized for each partitioned map (each partitioned map is formed in such a way as to be a map whose aspect ratio is a square one (referred to as a “parcel map” from here on)), as shown in FIG. 2(b). Therefore, in all the parcel maps, the aspect ratio is a square one. More specifically, as shown in A′ and B′ of FIG. 2(b), the aspect ratios of parcels also at any different points are equal.

However, in the case of a map in which the earth is partitioned into map parts by latitude and longitude, because the earth is spherical, the aspect ratios of map parts differ from each other when their latitudes differ from each other. More specifically, as shown in A and B of FIG. 2(a), at points where latitudes differ from each other, the aspect ratios of partitioned map parts differ from each other. Therefore, when the parcel maps are drawn just as they are, a distortion occurs between a parcel map and the actual map with distance from a latitude serving as a reference. Therefore, it is necessary to correct the aspect ratios of the parcels and draw these parcels.

However, when a different aspect ratio is set to each of the parcels, because parcel boundaries become discontinuous, the aspect ratio of a representative point is determined and its value is used. When the pixel coordinates of a target screen to be drawn are expressed by W, conversion from the coordinates of each parcel map can be expressed by the following equations (1).

$$( \begin{matrix}Wx \\ Wy\end{matrix} ) = ( \begin{matrix}A [ 0 ] & A [ 1 ] \\ A [ 2 ] & A [ 3 ]\end{matrix} ) ( \begin{matrix}dAbsX \\ dAbxY\end{matrix} ) + ( \begin{matrix}dispCenterWinX \\ dispCenterWinY\end{matrix} ) \\ dAbsX = absX - dispCenterAbsX \\ dAbsY = absY - dispCenterAbsY \\ absX = Px + ParcelLBX \\ absY = Py + ParcelLBY \\ Abs 2 Win [ 0 ] = win\_abs \_ratio \\ Abs 2 Win [ 1 ] = win\_abs \_ratio \times xyratio \\ Abs 2 Win [ 2 ] = - win\_abs \_ratio \\ Abs 2 Win [ 3 ] = - win\_abs \_ratio \times xyratio \qquad ( 1 )$$

In these equations, win_abs_ratio is the ratio of the pixel coordinates and absolute normalized coordinates, xyratio is the parcel aspect ratio of the representative point, P is the parcel coordinates, ParcelLB is the absolute normalized coordinates of the lower left corner of each parcel, dispCenterAbs is a display center expressed as absolute normalized coordinates, and dispCenterWin is the display center expressed as pixel coordinates.

In the parcel aspect ratio calculator 4, the aspect ratio which is used in this calculator is calculated. This parcel aspect ratio can be determined from the latitude lat of the representative point according to the following equation (2). By using, as this representative point, the current display center, the difference between the map at the time of drawing the spherical object from an arbitrary eyepoint and the planar map can be minimized.

xyratio=cos(lat) (2)

The polygon generator 5 which has received the parcel aspect ratio from the parcel aspect ratio calculator 4 while receiving the map data from the map data acquirer 3 generates a polygon for map drawing on the basis of these map data and parcel aspect ratio. A concrete operation is performed as follows.

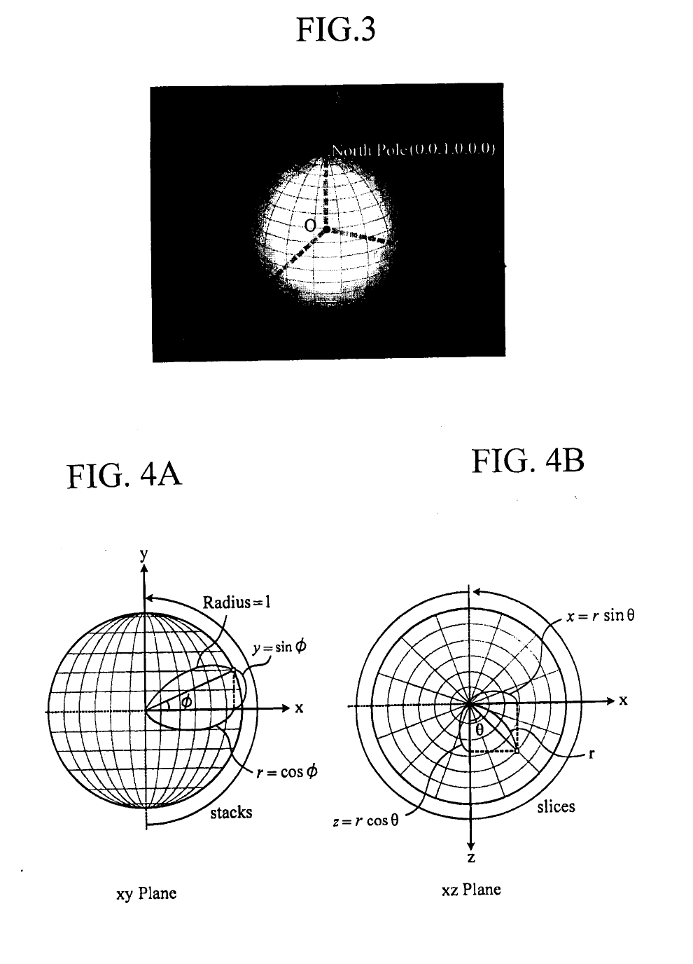

First, the spherical polygon coordinate calculator 6 of the polygon generator 5 calculates the coordinates of each vertex of each polygon which constructs the earth object. The coordinate system of a polygon which constructs the earth object is set up in such a way that, as shown in FIG. 3, the center of the earth is defined as a point of origin O, an axis connecting between a point at 0 degrees north and 90 degrees east, and a point at 0 degrees north and 90 degrees west is defined as an x axis, an axis connecting between the two poles (north pole and south pole) is defined as a y axis, an axis connecting between a point at 0 degrees north and 0 degrees east and a point at 0 degrees north and 180 degrees east is defined as a z axis. The size is assumed to be a radius of 1. When each vertex of each polygon is a point of intersection between a latitude line and a longitude line, the number which is obtained by dividing 360 degrees of longitude lines by a degree of degₓ is expressed by slices, the number which is obtained by dividing 180 degrees of latitude lines by a degree of deg_{y} is expressed by stacks, a point at 180 degrees west is defined as the starting point of slices, and a point at 90 degrees south is defined as the starting point of stacks, each vertex S(sx, sy, sz) of the polygon which constructs the earth object can be determined according to the following equations (3).

$$( {sx}_{n m} , {sy}_{mn} , {sz}_{n m} ) = ( cos {ϕ}_{n} sin {ϑ}_{m} , sin {ϕ}_{n} , cos {ϕ}_{n} cos {ϑ}_{m} ) \\ ( {ϑ}_{m} , {ϕ}_{n} ) = ( - π + ( \frac{2 π}{slices} \times m ) , - \frac{π}{2} + ( \frac{π}{stacks} \times n ) ) \qquad ( 3 )$$

In these equations, n is an index of each of positions which are acquired by dividing the latitude lines into equal parts along a direction from 90 degrees south toward 90 degrees north, as shown in FIG. 4(a), and m is an index of each of positions which are acquired by dividing the longitude lines into equal parts along a direction from 180 degrees west toward 180 degrees east, as shown in FIG. 4(b).

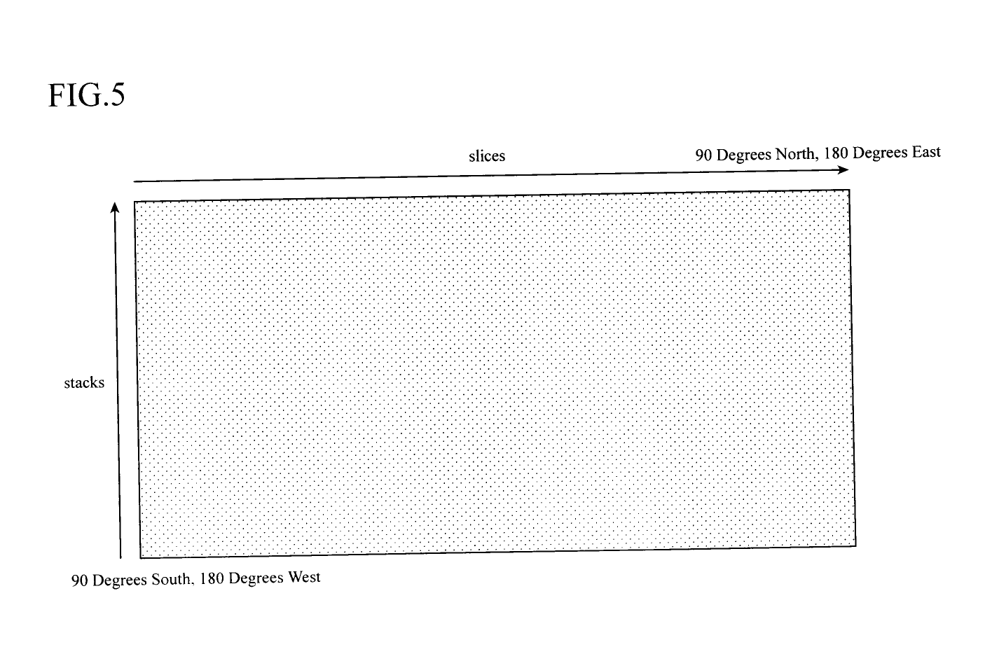

Further, assuming that the lower left corner of a texture image shown in FIG. 5 is 90 degrees south and 180 degrees west, and the upper right corner is 90 degrees north and 180 degrees east, because the lower left corner is (0.0, 0.0), and the upper right corner is (1.0, 1.0) in the texture coordinate system, the texture coordinates (u, v) of each vertex of each polygon can be determined according to the following equation (4).

$$( {u}_{n m} , {v}_{n m} ) = ( \frac{m}{slices} , \frac{n}{stacks} ) \qquad ( 4 )$$

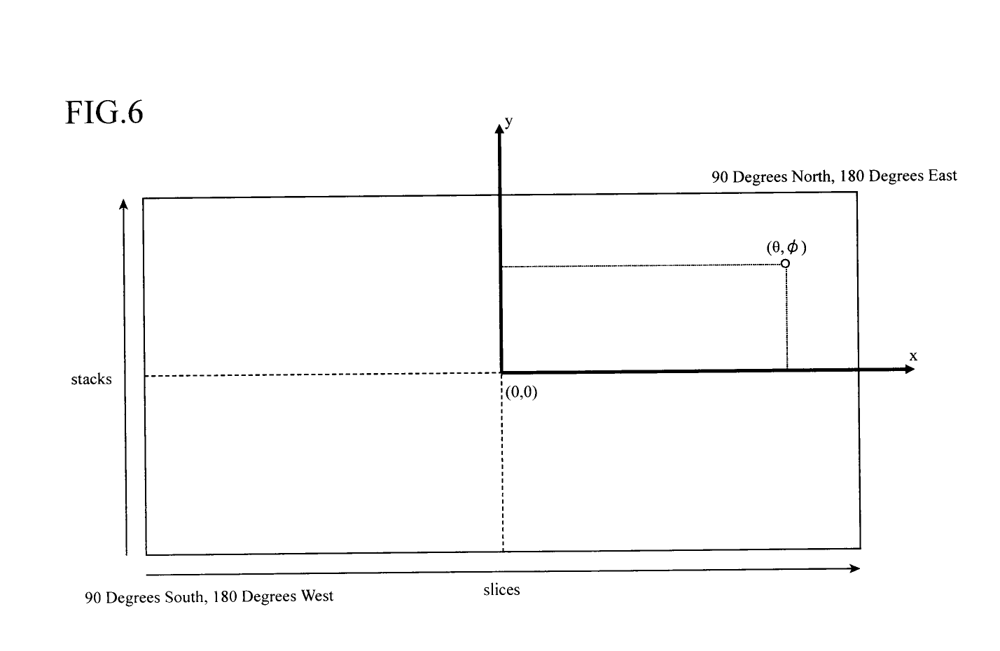

On the other hand, the planar polygon coordinate calculator 7 of the polygon generator 5 calculates the coordinates of each vertex of each polygon which constructs the planar map. The coordinate system of a polygon which constructs the planar map is set up in such a way that, as shown in FIG. 6, the point at 0 degrees north and 0 degrees east is defined as a point of origin, an axis connecting between the point at 0 degrees north and 0 degrees east and the point at 0 degrees north and 180 degrees east is defined as an x axis, and an axis connecting between the point at 0 degrees north and 0 degrees east, and a point at 90 degrees north and 0 degrees east is defined as a y axis. This XY plane is assumed to exist at z=1. At that time, the coordinates P(px, py, pz) of each vertex of each polygon which constructs the plane can be determined according to the following equation (5).

(pxₙₘ,pyₙₘ,pzₙₘ)=(θₙ,φₘ,1) (5)

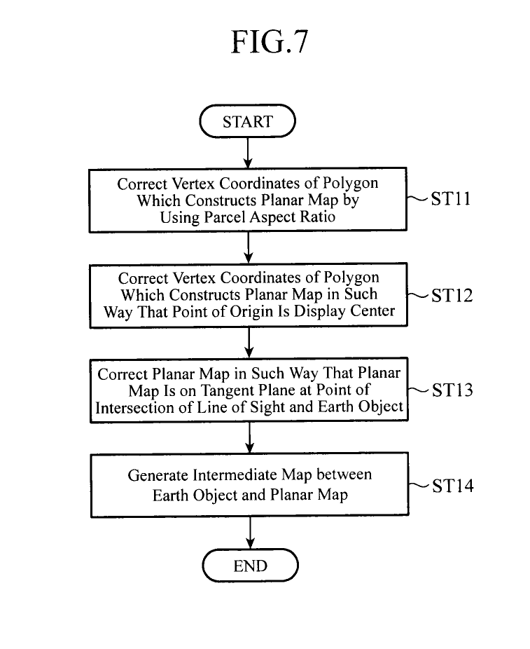

When the coordinates of each vertex of each polygon which constructs the earth object and the coordinates of each vertex of each polygon which constructs the planar map are calculated in this way, the intermediate polygon coordinate calculator 8 of the polygon generator 5 then calculates the polygon coordinates which construct an intermediate map between the earth object and the planar map on the basis of both the vertex coordinates from the spherical polygon coordinate calculator 6, and the vertex coordinates from the planar polygon coordinate calculator 7. This process will be explained with reference to a flow chart shown in FIG. 7.

First, the vertex coordinates of a polygon which constructs the planar map are corrected by using the parcel aspect ratio (step ST11). As shown in the above-mentioned equation (5), the vertices of the polygon which constructs the planar map have a square ratio of the X-direction to the Y-direction. Therefore, the intermediate polygon coordinate calculator 8 determines the vertex coordinates P′(px′, py′, pz′) corrected according to the following equation (6) by using the parcel aspect ratio sent thereto from the parcel aspect ratio calculator 4.

(px′ₘₙ,py′ₘₙ,pz′ₘₙ)=(xyratio×,pxₘₙ,pyₘₙ,1) (6)

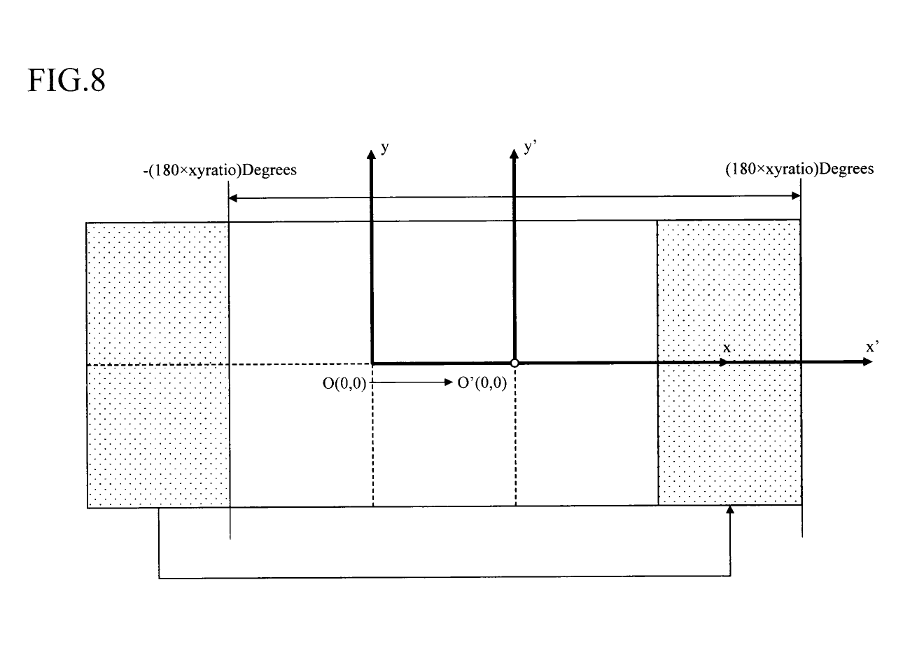

The coordinates of each vertex of each polygon which constructs the planar map are then corrected in such a way that the point of origin becomes the display center (step ST12). At that time, when the x-coordinates of the polygon do not fall within a range of ±(180×xyratio) degrees with respect to the corrected center, as shown in FIG. 8, the intermediate polygon coordinate calculator 8 corrects the vertex coordinates of the polygon in such a way that the x-coordinates fall within the range of ±(180×xyratio) degrees, according to the following equation (7). As a result, even in a case of displaying a vicinity of a boundary of the original planar map, the map can be displayed without breaks.

$${px}^{′} = \{ \begin{matrix}px & ( - 180 \times xyratio \leq px \leq 180 \times xyratio ) \\ px + 360 \times xyratio & ( px < - 180 \times xyratio ) \\ px - 360 \times xyratio & ( px > 180 \times xyratio )\end{matrix} \qquad ( 7 )$$

The corrected planar map is then corrected onto the tangent plane at the point of intersection of the line of sight and the earth object (step ST13). Because the planar map is the tangent plane at (0, 0, z) of the earth object, i.e., the tangent plane in the case of defining the position of zero degrees longitude and zero degrees latitude as the eyepoint, the tangent plane at the point of intersection of the line of sight and the earth object can be determined by rotating the planar map by using the longitude and latitude values at the display center. Each vertex P′(px′, py′, pz′) which constructs the tangent plane rotated can be determined according to the following equation (8).

$$( \begin{matrix}{px}_{mn}^{″} \\ {py}_{mn}^{″} \\ {pz}_{mn}^{″}\end{matrix} ) = {R}_{y} ( ϑ ) {R}_{x} ( ϕ ) ( \begin{matrix}{px}_{mn}^{′} \\ {py}_{mn}^{′} \\ {pz}_{mn}^{′}\end{matrix} ) \qquad ( 8 )$$

After that, an intermediate map between the earth object and the planar map on the tangent plane is generated (step ST14). In order to generate this intermediate map, the intermediate polygon coordinate calculator 8 calculates a difference value D(dx, dy, dz) between each vertex of each polygon which constructs the earth object, and each vertex of each polygon which constructs the planar map on the tangent plane first according to the following equation (9).

$$( \begin{matrix}dx \\ dy \\ dz\end{matrix} ) = ( \begin{matrix}sx - {px}^{″} \\ sy - {py}^{″} \\ sz - {pz}^{″}\end{matrix} ) \qquad ( 9 )$$

The intermediate polygon coordinate calculator 8 then determines the coordinates of each vertex of each polygon of the intermediate map by adding the calculated difference value to the coordinates of each vertex of each polygon which constructs the earth object according to a time t during the transition. When a transition time is expressed by T, the coordinates M(mx, my, mz) of each vertex of each polygon of the intermediate map can also be determined according to the following equation (10).

$$( \begin{matrix}{mx}_{mn} \\ {my}_{mn} \\ {mz}_{mn}\end{matrix} ) = ( \begin{matrix}{sx}_{mn} \\ {sy}_{mn} \\ {sz}_{mn}\end{matrix} ) + ( \begin{matrix}{dx}_{mn} \\ {dy}_{mn} \\ {dz}_{mn}\end{matrix} ) t / T \qquad ( 10 )$$

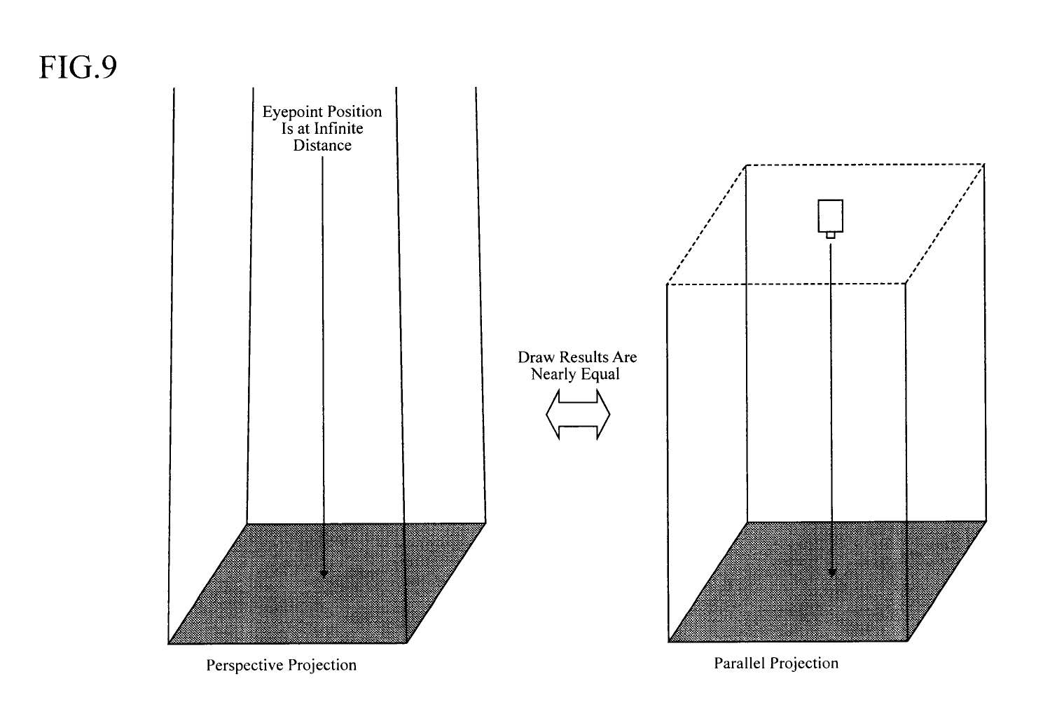

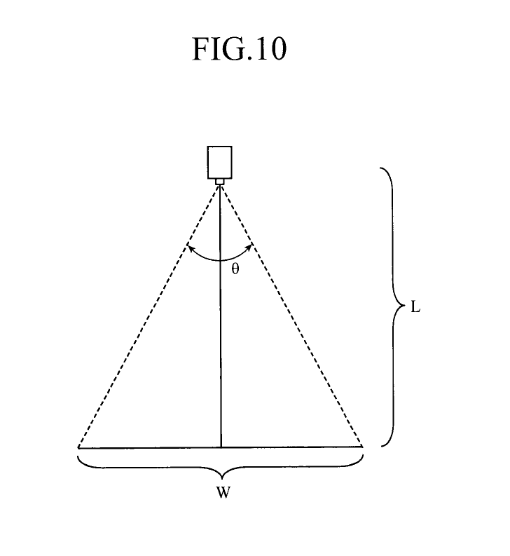

On the other hand, the eyepoint position calculator 9 calculates an eyepoint position parameter showing the eyepoint position at the time of drawing the intermediate map during the transition on the basis of the polygon from the polygon generator 5, and sends the eyepoint position parameter to the drawer 10. It is desirable that the earth object is drawn by using a perspective projection because the earth object is a three-dimensional map, and the planar map is drawn by using a parallel projection because the planar map is a two-dimensional map. Therefore, it is necessary to change the projection method gradually during the transition. To this end, as shown in FIG. 9, by using the fact that the perspective projection from an infinite distance can implement substantially the same appearance as that provided by the parallel projection, a smooth transition between the perspective projection and the parallel projection is implemented. First, when a display area is expressed by W, a visual object distance is expressed by L, and an angle of view is expressed by 0, as shown in FIG. 10, a relation among these values can be expressed by the following equation (11).

$$L = \frac{W}{2 tan ϑ / 2} \qquad ( 11 )$$

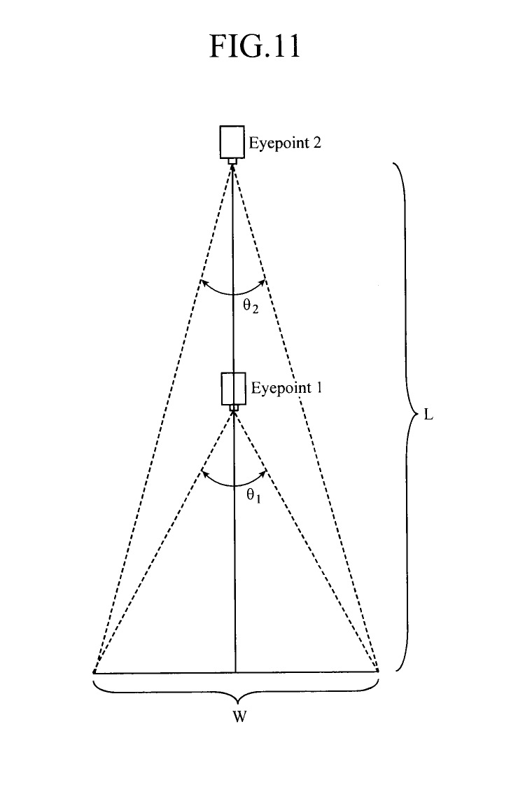

When moving from an eyepoint 1 shown in FIG. 11 to an eyepoint 2 for the period of time of T, a change Δθ per unit time of the angle of view can be expressed by the following equation (12). Further, the visual object distance L at the time t can be determined according to the following equation (13).

$$\begin{matrix}Δ ϑ = \frac{{ϑ}_{2} - {ϑ}_{1}}{T} & ( 12 ) \\ L = \frac{W}{2 tan ( \frac{( {ϑ}_{2} - {ϑ}_{1} )}{2 T} + t + \frac{{ϑ}_{1}}{2} )} & ( 13 )\end{matrix}$$

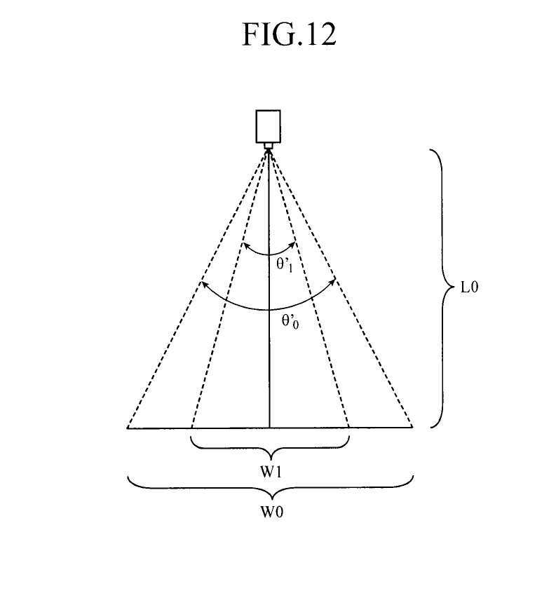

What is needed in order to bring the appearance in the case of the perspective projection close to that in the case of the parallel projection is just to bring the angle of view close to 0, as shown in FIG. 9. More specifically, what is needed in order to make a smooth transition from the perspective projection to the parallel projection is just to bring the angle of view close to 0 with the display area being maintained while increasing the visual object distance. By then switching to the parallel projection finally, it becomes possible to make a smooth transition from the perspective projection to the parallel projection. Further, in order to perform a scale change at the time of this transition, it is necessary to change the angle of view or the visual object distance. Hereafter, a case of changing the angle of view will be explained as an example. In order to perform a scale change, i.e., change the display area from W0 to W1, as shown in FIG. 12, it is necessary to change the angle of view from θ₀′ to θ₁′. Therefore, the display area W at the time t can be determined according to the following equation (14).

$$W = 2 {L}_{0 } sin ( \frac{( {ϑ}_{1}^{′} - {ϑ}_{0}^{′} )}{2 T} t + \frac{{ϑ}_{0}^{′}}{2} ) \qquad ( 14 )$$

As a result, the visual object distance L in the case of a combination with the scale change can be determined according to the following equation (15), which is acquired by combining the equations (13) and (14).

$$L = \frac{{L}_{0} sin ( \frac{( {ϑ}_{1}^{′} - {ϑ}_{0}^{′} )}{2 T} t + \frac{{ϑ}_{0}^{′}}{2} )}{tan ( \frac{( {ϑ}_{2} - {ϑ}_{1} )}{2 T} t + \frac{{ϑ}_{1}}{2} )} \qquad ( 15 )$$

The drawer 10 which has received both the polygon which constructs the intermediate map shown by the polygon coordinates from the polygon generator 5 and the eyepoint position parameter determined by the eyepoint position calculator 9, after the above-mentioned process, performs three-dimensional drawing by using both these polygon and eyepoint position parameter, the polygon constructing the intermediate map. As a result, the intermediate map during the process of making a transition between the earth object and the planar map can be drawn.

As previously explained, because the map drawing device in accordance with Embodiment 1 includes the parcel aspect ratio calculator 4 and the polygon generator 5, and generates an intermediate map between an earth object and a planar map by using an aspect ratio which can minimize a difference between a map at the time of drawing a spherical object from an arbitrary eyepoint and the planar map, the map drawing device can make a transition between the earth object and the planar map without providing a feeling that something is abnormal. The map drawing device further includes the eyepoint position calculator 9, determines an eyepoint position parameter showing an eyepoint position which makes it possible to perform a scale change while changing a projection method continuously, and generates the intermediate map by using this eyepoint position parameter, the map drawing device can make a transition between the earth object and the planar map while performing a scale change without providing a feeling that something is abnormal.

While the invention has been described in its preferred embodiment, it is to be understood that various changes can be made in an arbitrary component according to the embodiment, and an arbitrary component according to the embodiment can be omitted within the scope of the invention.

### INDUSTRIAL APPLICABILITY

Because the map drawing device in accordance with the present invention makes it possible to make a transition between an earth object which consists of a polygon, and a planar map which is drawn by using a vector map, errors occurring between the earth and the planar map can be reduced. As a result, because the appearance of the map does not change a lot when switching between the earth and the planar map according to a scale change, the map drawing device in accordance with the present invention does not provide the user with a feeling that something is abnormal, and is suitable for a map display which is produced in a car navigation system or a portable device.

### EXPLANATIONS OF REFERENCE NUMERALS

1 map database, 2 controller, 3 map data acquirer, 4 parcel aspect ratio calculator, 5 polygon generating part, 6 spherical polygon coordinate calculator, 7 planar polygon coordinate calculator, 8 intermediate polygon coordinate calculator, 9 eyepoint position calculator, and 10 drawer.

1-3. (canceled)

4. A map drawing device comprising:
a map data acquirer that acquires map data;
a parcel aspect ratio calculator that calculates an aspect ratio of parcels on a basis of a position of a display center of a map in a case of drawing a spherical object from an arbitrary eyepoint on a basis of the map data acquired by said map data acquirer;
a polygon generator that generates a polygon for drawing an intermediate map between an earth object and a planar map on a basis of the aspect ratio of parcels which is calculated by said parcel aspect ratio calculator; and
a drawer that draws the intermediate map on a basis of the polygon generated by said polygon generator.

5. The map drawing device according to claim 4, wherein
said polygon generator includes a spherical polygon coordinate calculator that calculates coordinates of each vertex of each polygon which constructs the earth object, a planar polygon coordinate calculator that calculates coordinates of each vertex of each polygon which constructs the planar map, and an intermediate polygon coordinate calculator that calculates polygon coordinates which are coordinates of each vertex of each polygon which constructs the intermediate map between the earth object and the planar map on a basis of both the vertex coordinates from said spherical polygon coordinate calculator and the vertex coordinates from said planar polygon coordinate calculator, and outputs the polygon coordinates as the polygon for drawing the intermediate map.

6. The map drawing device according to claim 4, wherein said map drawing device includes an eyepoint position calculator that calculates an eyepoint position parameter showing an eyepoint position which makes it possible to change a scale while continuously changing between a perspective projection and a parallel projection, and wherein said drawer draws the intermediate map between the earth object and the planar map by using both the polygon from said polygon generator and the eyepoint position parameter from said eyepoint position calculator.

7. A map drawing device comprising:
a map data acquirer that acquires map data;
a parcel aspect ratio calculator that calculates an aspect ratio of parcels which can minimize a difference between a map in a case of drawing a spherical object from an arbitrary eyepoint on a basis of the map data acquired by said map data acquirer, and a planar map;
a polygon generator that generates a polygon for drawing an intermediate map between an earth object and a planar map on a basis of the aspect ratio of parcels which is calculated by said parcel aspect ratio calculator; and
a drawer that draws the intermediate map on a basis of the polygon generated by said polygon generator.

8. The map drawing device according to claim 7, wherein
said polygon generator includes a spherical polygon coordinate calculator that calculates coordinates of each vertex of each polygon which constructs the earth object, a planar polygon coordinate calculator that calculates coordinates of each vertex of each polygon which constructs the planar map, and an intermediate polygon coordinate calculator that calculates polygon coordinates which are coordinates of each vertex of each polygon which constructs the intermediate map between the earth object and the planar map on a basis of both the vertex coordinates from said spherical polygon coordinate calculator and the vertex coordinates from said planar polygon coordinate calculator, and outputs the polygon coordinates as the polygon for drawing the intermediate map.

9. The map drawing device according to claim 7, wherein said map drawing device includes an eyepoint position calculator that calculates an eyepoint position parameter showing an eyepoint position which makes it possible to change a scale while continuously changing between a perspective projection and a parallel projection, and wherein said drawer draws the intermediate map between the earth object and the planar map by using both the polygon from said polygon generator and the eyepoint position parameter from said eyepoint position calculator.
